(19) United States
(12) Patent Application Publication
(10) Pub. No.: US 2025/0077961 A1
(43) Pub. Date: Mar. 6, 2025

(54) MACHINE LEARNING MODEL EVALUATION

(71) Applicant: Capital One Services, LLC, McLean, VA (US)

(72) Inventors: Sreekanth CHINTHAGUNTA, Mckinney, TX (US); Alexander BURDICK, Frisco, TX (US)

(21) Appl. No.: 18/462,019

(22) Filed: Sep. 6, 2023

(51) Int. Cl. G06N 20/00

(52) U.S. Cl. CPC G06N 20/00

(57) ABSTRACT

In some implementations, a device may obtain, via application infrastructure associated with an application, data associated with the application, the data including a first one or more outputs of a first machine learning model that is deployed via the application infrastructure. The device may generate a second one or more outputs of a second machine learning model. The device may replace the first one or more outputs with the second one or more outputs in the data to generate modified data. The device may provide, via the application infrastructure, the modified data to a processing component of the application. The device may obtain, based on providing the modified data, evaluation information indicating a performance level of the second machine learning model.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for machine learning model evaluation. The system may include one or more memories and one or more processors communicatively coupled to the one or more memories. The one or more processors may be configured to obtain, via application infrastructure associated with an application, data associated with the application, the data including a first one or more outputs of a deployed machine learning model associated with the application, wherein the first one or more outputs are based on input data associated with the application. The one or more processors may be configured to generate, based on the input data, a second one or more outputs of a test machine learning model. The one or more processors may be configured to modify the data to obtain modified data associated with the application, wherein the modified data includes the second one or more outputs in place of the first one or more outputs. The one or more processors may be configured to provide, via the application infrastructure, the modified data to a processing component of the application. The one or more processors may be configured to obtain, based on providing the modified data, evaluation information indicating a performance level of the test machine learning model. The one or more processors may be configured to perform one or more actions based on the performance level.

Some implementations described herein relate to a method for machine learning model evaluation. The method may include obtaining, by a device and via application infrastructure associated with an application, data associated with the application, the data including a first one or more outputs of a first machine learning model that is deployed via the application infrastructure. The method may include generating, by the device, a second one or more outputs of a second machine learning model. The method may include replacing, by the device, the first one or more outputs with the second one or more outputs in the data to generate modified data. The method may include providing, by the device and via the application infrastructure, the modified data to a processing component of the application. The method may include obtaining, by the device and based on providing the modified data, evaluation information indicating a performance level of the second machine learning model.

Some implementations described herein relate to a non-transitory computer-readable medium that stores a set of instructions. The set of instructions, when executed by one or more processors of a device, may cause the device to generate, via application infrastructure associated with an application, data associated with the application, the data including a first one or more outputs of a deployed machine learning model associated with the application. The set of instructions, when executed by one or more processors of the device, may cause the device to obtain a second one or more outputs of a test machine learning model. The set of instructions, when executed by one or more processors of the device, may cause the device to modify the data to obtain modified data associated with the application, wherein the modified data includes the second one or more outputs in place of the first one or more outputs. The set of instructions, when executed by one or more processors of the device, may cause the device to provide, via the application infrastructure, the modified data to a processing component of the application. The set of instructions, when executed by one or more processors of the device, may cause the device to obtain, based on providing the modified data and via the application infrastructure, evaluation information indicating a performance level of the test machine learning model.

### BRIEF DESCRIPTION OF THE DRAWINGS

FIGS. 1A-1C are diagrams of an example associated with machine learning model evaluation, in accordance with some embodiments of the present disclosure.

FIG. 2 is a diagram of an example associated with machine learning model evaluation, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with machine learning model evaluation, in accordance with some embodiments of the present disclosure.

FIG. 5 is a flowchart of an example process associated with machine learning model evaluation, in accordance with some embodiments of the present disclosure.

### DETAILED DESCRIPTION

The following detailed description of example implementations refers to the accompanying drawings. The same reference numbers in different drawings may identify the same or similar elements.

Developing a machine learning (ML) model for an application involves several stages, from data collection and preprocessing to model development, testing, and/or deployment, among other examples. In some examples, to test an ML model, the ML model may be deployed in an application infrastructure to ensure the compatibility of the machine learning model with the application infrastructure. For example, an ML model may be developed and/or trained (e.g., via feature engineering and/or selection, model selection, model training, and/or model evaluation or tuning). After the ML model has been developed and/or trained, the ML model may be deployed in an application infrastructure to make the ML model available to an application. The application infrastructure may be a computing environment in which one or more applications are executed. For example, the application infrastructure may include technologies, services, and/or computing resources that support the deployment and execution of one or more applications.

For example, in a testing stage, an ML model that has been developed and trained may be prepared for deployment within the application infrastructure. This process may involve integrating the ML model into the existing application environment (e.g., the existing application infrastructure) and ensuring that the ML operates smoothly when deployed in the application infrastructure. For example, the ML model may be serialized into a format that can be easily stored and transferred (such as JSON). The application infrastructure may be prepared to host the ML model, such as by setting up one or more servers, cloud resources, container environments, and/or other computing hardware to host the ML model (e.g., depending on the architecture and scalability requirements of the application). An application programming interface (API) may be created to expose a functionality of the ML model to the application (e.g., the API may define endpoints through which the application can transmit data to the ML model for inference).

Additionally, during the testing stage, the ML model may be integrated into the application infrastructure (e.g., to ensure that the ML model can be accessed and utilized by the application). For example, the API associated with the ML model may be integrated into the application infrastructure (e.g., by integrating the API endpoints with backend or middleware of the application infrastructure, enabling the application to transmit requests to the ML model). Additionally, one or more data preprocessing operations may be performed to ensure that the preprocessing in the application infrastructure (e.g., for data to be provided to the ML model) aligns with preprocessing of data that was performed in a model training stage of the ML model. As another example, one or more optimization operations may be performed, such as batching operations and/or caching operations, to improve performance of the ML model in the application infrastructure.

After the machine learning model is integrated into the application infrastructure, the ML model may undergo rigorous testing to ensure that the ML functions as expected in a real-world environment (e.g., as deployed in the application infrastructure). By thoroughly testing the deployed machine learning model within the application infrastructure, any potential issues can be identified and resolved before the ML model is deployed to production. However, preparing the ML model and/or the application infrastructure for the ML model to be integrated in the application infrastructure, integrating and/or deploying the ML model in the application infrastructure, and/or performing testing of the ML model deployed in the application infrastructure may consume significant time, computing resources, memory resources, and/or processing resources, among other examples. In some examples, different teams of developers may performing training of the ML model and deployment and/or integration of the ML model into the application infrastructure. As a result, a significant delay in testing and/or deploying the ML model (e.g., to be used in production) may be introduced because a team associated with developing and/or training the ML model may need to wait for another team of developers to prepare the ML model and/or the application infrastructure for the ML model to be integrated in the application infrastructure, integrate and/or deploy the ML model in the application infrastructure, perform testing of the ML model deployed in the application infrastructure, and/or provide testing results for the ML model to the team associated with developing and/or training the ML model.

Some implementations described herein enable improved ML model evaluation. For example, some implementations described herein may enable testing of an ML model for an application infrastructure without deploying the ML model in the application infrastructure. In some implementations, an ML model may use data that is prepared and/or preprocessed in the application infrastructure (e.g., prepared and/or preprocessed for another ML model) to perform one or more inferences (e.g., to generate one or more outputs). A model evaluation device may obtain first output information from another ML model deployed in the application infrastructure (e.g., output information that is generated based on the data that is prepared and/or preprocessed in the application infrastructure). The model evaluation device may obtain second output information from the ML model (e.g., the ML model being tested). The model evaluation device may replace the first output information with the second output information (e.g., in a dataset to be used by the application). The model evaluation device may provide, to one or more processing components of the application infrastructure, the dataset (e.g., with the second output information). The one or more processing components may perform one or more operations using the dataset. The application infrastructure may output evaluation information that can be used to evaluate a performance of the ML model (e.g., the ML model being tested).

For example, the model evaluation device may generate, via application infrastructure associated with an application, data associated with the application. The data may include a first one or more outputs of a deployed ML model associated with the application. The model evaluation device may obtain, based on the input data, a second one or more outputs of a test ML model (e.g., a test ML model may refer to an ML model being tested). For example, the test ML model may not be deployed or integrated in the application infrastructure. The model evaluation device may modify the data to obtain modified data associated with the application. The modified data may include the second one or more outputs in place of the first one or more outputs. The model evaluation device may provide, via the application infrastructure, the modified data to a processing component of the application. The model evaluation device may obtain, based on providing the modified data, evaluation information indicating a performance level of the test ML model. The model evaluation device may perform one or more actions based on the performance level.

As a result, the model evaluation device may be enabled to obtain evaluation information for an ML model (e.g., indicating the performance level of the ML model in a real-world application infrastructure) without deploying or integrating the ML model in the application infrastructure. This conserves time, computing resources, memory resources, and/or processing resources, among other examples, that would have otherwise been used associated with preparing the test ML model and/or the application infrastructure for the test ML model to be integrated in the application infrastructure, integrating and/or deploying the test ML model in the application infrastructure, and/or performing testing of the test ML model deployed in the application infrastructure, among other examples. Additionally, this reduces a development time associated with ML models and enables the test ML model to be deployed in production quicker.

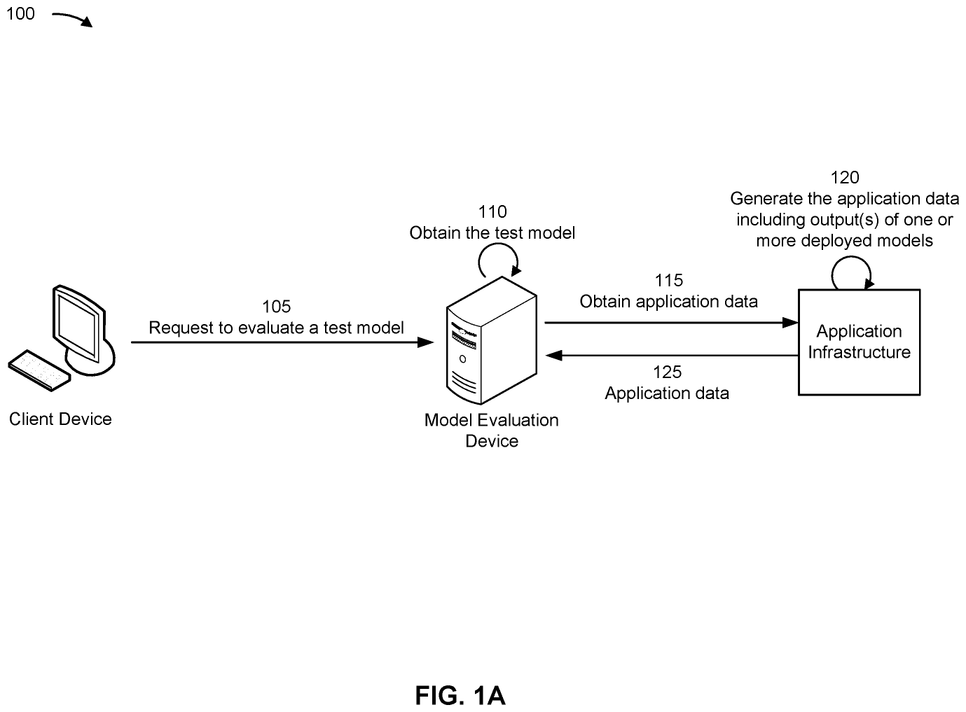

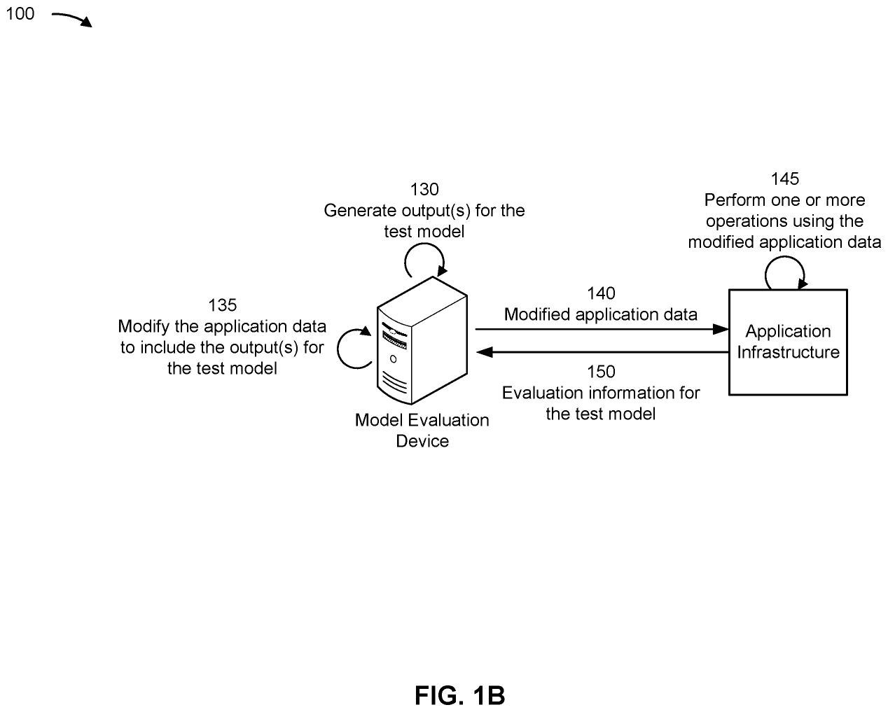

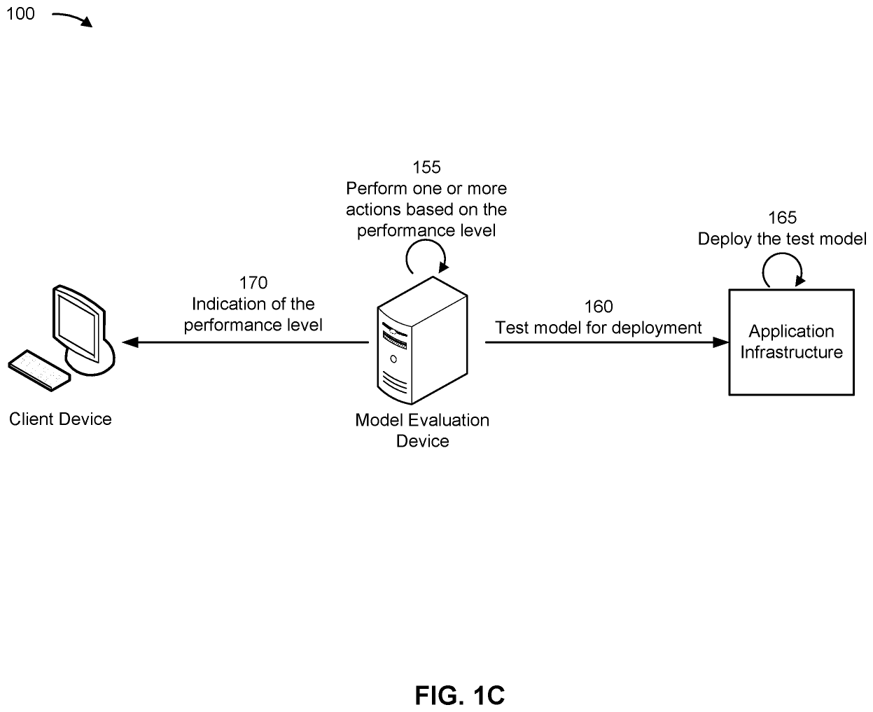

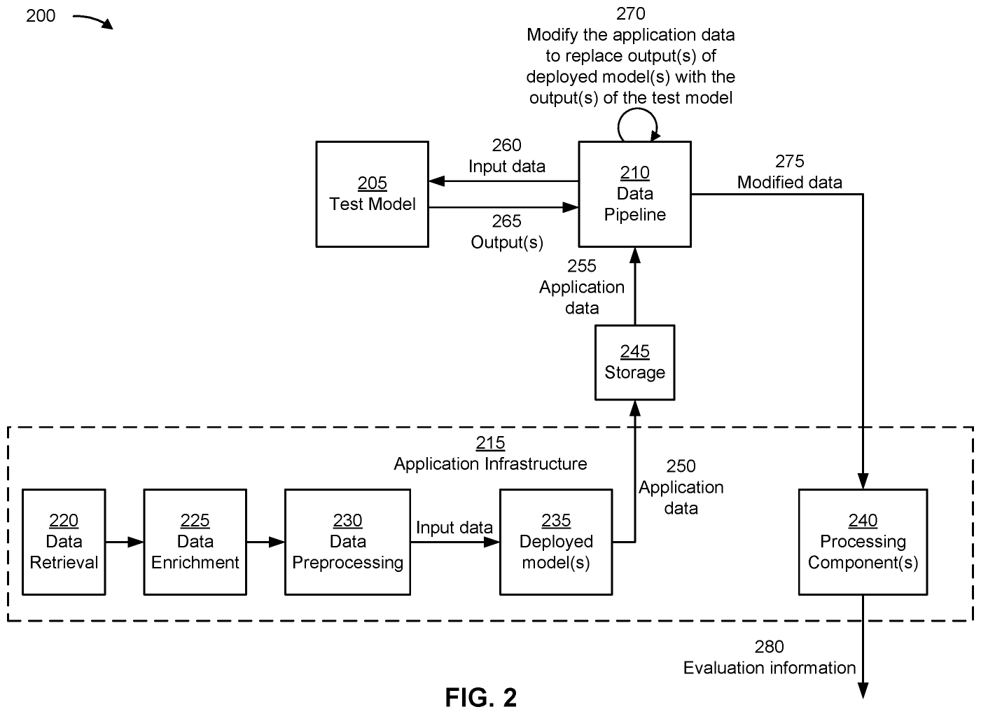

FIGS. 1A-1C are diagrams of an example 100 associated with machine learning model evaluation. As shown in FIGS. 1A-1C, example 100 includes a model evaluation device, a client device, and an application infrastructure. These devices are described in more detail in connection with FIGS. 2, 3, and 4.

As shown in FIG. 1A, and by reference number 105, the client device may transmit, and the model evaluation device may receive, a request to evaluate a test model (e.g., a test ML model). As used herein, “test model” or “test ML model” may refer to a model (e.g., an ML model) that is to be tested. “Model” and “machine learning model” may be used interchangeably herein. The test model may be a trained ML model that is not deployed in the application infrastructure. For example, the client device, the model evaluation device, and/or another device may train the test model using historical data. In some implementations, the historical data may be processed and/or preprocessed in a similar (or the same) manner as data processing and/or data preprocessing that is performed via the application infrastructure.

For example, the model evaluation device may receive a request to perform testing of the ML model via the application infrastructure. As an example, the client device may obtain a user input indicating the request to evaluate the test model. The client device may transmit the request based on, or in response to, obtaining the user input. Additionally, or alternatively, the client device may detect an event associated with evaluating the test model. For example, the event may include the test model being provided to and/or uploaded to the client device or to a platform executing on the client device. The client device may transmit the request based on, or in response to, detecting the event.

In some implementations, the model evaluation device may perform one or more operations (e.g., automatically) based on, or in response to, receiving the request. For example, the model evaluation device may be configured to automatically perform testing operations described herein for the test model based on, or in response to, receiving the request. In some other implementations, the model evaluation device may perform one or more operations (e.g., automatically) based on, or in response to, detecting an event, such as the test model being provided to and/or uploaded to the model evaluation device or to a platform (e.g., a testing platform or testing service). In such example, the model evaluation device may not receive the request from the client device, but may automatically perform one or more operations described herein based on, or in response to, detecting the event.

As shown by reference number 110, the model evaluation device may obtain the test model. For example, the model evaluation device may download and/or otherwise obtain the test model from another device, such as a server device or a cloud computing device or platform. In some implementations, obtaining the test model may include the model evaluation device determining a location (e.g., a storage location) associated with the test model to enable the model evaluation device to transmit requests and/or data to the test model. For example, the model evaluation device may determine or identify one or more API endpoints associated with the test model.

The test model may be any type of ML model. For example, the test model may be a gradient boosting machine (GBM) model, an extreme gradient boosting (XGBoost) model, a decision tree model, a regression model (e.g., a logistic regression model or a linear regression model), a classification model, a clustering model, a random forest model, and/or another type of ML model. For example, the test model may be configured to provide one or more outputs. In some implementations, the one or more outputs may be one or more scores. The one or more scores may be indicative a recommendation or inference associated with a target variable. For example, if the target variable is fraud, then the one or more scores may indicate a likelihood that fraud has occurred. As another example, the one or more outputs may be an inference, a recommendation, and/or another type of output.

As shown by reference number 115, the model evaluation device may transmit, the one or more components of the application infrastructure may receive, a request to obtain application data. In some implementations, the application infrastructure may include one or more modularized components. For example, the one or more modularized components may be configured to perform different operations associated with the application infrastructure. As an example, the application infrastructure may include one or more processing components (e.g., configured to process and/or use application data), an ML model component (e.g., also referred to herein as a scoring component), a data retrieval component, and/or a data preprocessing component, among other examples. For example, the ML model component may be configured to generate the application data by providing preprocessed data (e.g., from the data preprocessing component) to one or more ML models deployed via the application infrastructure. In other words, the application data may include one or more outputs (e.g., one or more scores) provided by the one or more ML models deployed via the application infrastructure.

In some implementations, one or more of the modularized component may be separately addressable by devices outside of the application infrastructure. For example, the model evaluation device (or another device) may configure the one or more modularized components of the application infrastructure. The configuration of a modularized component may include enabling a device outside of the application infrastructure (such as the model evaluation device) to transmit requests to and/or receive information (e.g., data) from the modularized component. For example, the configuration of a modularized component may include establishing one or more APIs associated with the modularized component. Additionally, or alternatively, the configuration of a modularized component may include configuring the modularized component to store data generated by the modularized component in a storage location that is accessible by a device outside of the application infrastructure (such as the model evaluation device). For example, the configuration of the ML model component (e.g., a scoring component) may include configuring the ML model component to store application data (e.g., generated via the ML model component of the application infrastructure) in a given storage location (e.g., in a temporary storage location in a cloud computing environment).

In some implementations, the configuration of the ML model component (e.g., a scoring component) may include configuring the ML model component to store application data in a temporary storage location in response to the application infrastructure receiving a request (e.g., from the model evaluation device) to obtain the application data and/or to test an ML model. For example, the application infrastructure may be configured with a test mode that enables ML models to be tested for the application infrastructure without the ML models being deployed in the ML models. Based on, or in response to, receiving a request to obtain application data and/or to test an ML model (e.g., from the model evaluation device, such as depicted by reference number 115), the application infrastructure may activate the test mode. If the test mode is activated, the application infrastructure (e.g., the ML model component) may be configured to store application data (e.g., generated via the ML model component of the application infrastructure) in a given storage location (e.g., to make the application data accessible to the model evaluation device before the application data is processed via one or more processing components of the application infrastructure). The application infrastructure (e.g., the ML model component) may be configured to store application data (e.g., generated via the ML model component of the application infrastructure) in the given storage location rather than, or in addition to, providing the application data to the one or more processing components of the application infrastructure.

As shown by reference number 120, the application infrastructure (e.g., one or more modularized components of the application infrastructure) may generate the application data. The application data may include one or more outputs of one or more deployed models. A deployed model may be a machine learning model that is deployed in the application infrastructure (e.g., via the ML model component). In some implementations, the application infrastructure may generate, via application infrastructure associated with an application, data associated with the application (e.g., application data). The data including a first one or more outputs of a deployed machine learning model associated with the application. The first one or more outputs may be based on input data associated with the application, as described in more detail elsewhere herein. In some implementations, generating the application data associated with the application may be in response to the request (e.g., from the model evaluation device, as depicted and described in connection with reference number 115).

For example, the application infrastructure may obtain or retrieve data. The application infrastructure may perform one or more data enrichment operations and/or one or more data preprocessing operations to generate input data. The input data may be data that is to be input to the one or more deployed models. The application infrastructure may provide the input data to the one or more deployed models. The application infrastructure may obtain, via the ML model component of the application infrastructure, the application data (e.g., indicating the one or more outputs of one or more deployed models). For example, the data (e.g., the application data) may be generated via a scoring component (e.g., an ML model component) of the application infrastructure. In some implementations, the application data may include other data in addition to the one or more outputs of one or more deployed models, such as account data, the input data, source data, and/or other data to be used and/or processed by one or more processing components of the application infrastructure.

As shown by reference number 125, the model evaluation device may obtain the application data. For example, the model evaluation device receives the application data from a component of the application infrastructure (such as the ML model component). Additionally, or alternatively, the model evaluation device may obtain or retrieve the application data from a storage location (e.g., a storage location in which the application infrastructure is configured to temporarily store the application data). For example, the model evaluation device may access the application data from a storage location (such as one or more memories in a cloud computing environment).

As shown in FIG. 1B, and by reference number 130, the model evaluation device may generate one or more outputs for the test model. For example, the model evaluation device may obtain, based on the input data, a second one or more outputs of the test ML model. The input data may be the same (or similar) input data provided by the application infrastructure to the one or more deployed ML models (e.g., the input data used by the application infrastructure to generate the application data). For example, in some implementations, the model evaluation device may obtain the input data (e.g., that has been retrieved, enriched, and/or preprocessed via the application infrastructure). In some implementations, the model evaluation device may obtain the input data from a component of the application infrastructure and/or from a storage location (e.g., in a similar manner as the model evaluation device obtains the application data).

In some other implementations, the model evaluation device may generate the input data. For example, the model evaluation device may obtain or retrieve, enrich, and/or preprocess data to obtain the input data (e.g., in the same or a similar manner as the application infrastructure, as described above). In this way, the model evaluation device may ensure that the input data used by the test model is the same, or similar, to the input data used in the actual application infrastructure.

The model evaluation device may provide, to the test model, the input data. The test model use the input data to generate one or more outputs (e.g., using one or more trained machine learning models). The test model may provide, and the model evaluation device may obtain, the one or more outputs associated with the test model. For example, the model evaluation device may provide, to the test model, preprocessed data (e.g., used by the application infrastructure to obtain the application data). The model evaluation device may obtain, based on providing the preprocessed data, the one or more outputs of the test model.

In some implementations, the first one or more outputs (e.g., generated via the one or more deployed models in the application infrastructure) and the second one or more outputs (e.g., generated via the test model) may both be associated with one or more target variables (e.g., the same one or more target variables). In other words, the deployed model(s) and the test model may be trained to predict, infer, and/or recommended information for the same one or more target variables. In other implementations, the first one or more outputs (e.g., generated via the one or more deployed models in the application infrastructure) may be associated with a first one or more target variables and the second one or more outputs (e.g., generated via the test model) may be associated with a second one or more target variables. In other words, the deployed model(s) and the test model may be trained to predict, infer, and/or recommended information for different target variables.

In some implementations, the first one or more outputs (e.g., generated via the one or more deployed models in the application infrastructure) may be associated with a data format. The model evaluation device may be configured to configure the second one or more outputs (e.g., generated via the test model) to have the data format. In other words, the model evaluation device may configure the output(s) from the test model in the same data format as a data format of the first one or more outputs (e.g., generated via the one or more deployed models in the application infrastructure) in the application data. For example, the application data may include one or more data fields indicating the first one or more outputs. The model evaluation may be configured to cause the second one or more outputs to have a format of the one or more data fields.

As shown by reference number 135, the model evaluation device may modify the application data to include the one or more outputs (e.g., the second one or more outputs) for the test model. For example, model evaluation device may modify the application data to obtain modified data associated with the application (e.g., modified application data). The modified application data may include the second one or more outputs (e.g., generated via the test model) in place of the first one or more outputs (e.g., generated via the one or more deployed models in the application infrastructure).

For example, the model evaluation device may replace, in the application data, the first one or more outputs with the second one or more outputs to generate modified data. In some implementations, the model evaluation device may replace the one or more data fields (e.g., that contained or indicated the first one or more outputs) with the second one or more outputs to obtain the modified data. For example, the model evaluation device may replace one or more columns in the application data (e.g., that indicated the output(s) of the deployed model(s)) with information indicative of the one or more outputs (e.g., the second one or more outputs) of the test model. By configuring the output(s) of the test model to have the same data format as the output(s) of the deployed model(s), a complexity associated with modifying the application data may be reduced.

In some implementations, such as when the deployed model(s) and the test model are associated with outputs directed to different target variables, the model evaluation device modify the application data to indicate the target variable(s) associated with the test model. For example, the model evaluation device may modify one or more identifiers of data fields and/or columns in the application data (e.g., data fields and/or columns that include the one or more outputs of the test model) to indicate the target variable(s) associated with the test model. This may enable the application infrastructure to identify the target variable(s) and to appropriately process and/or use the application data (e.g., based on the target variable(s)).

As shown by reference number 140, the model evaluation device may transmit or provide, and the application infrastructure may receive or obtain, the modified application data (e.g., that indicates the output(s) of the test model). For example, the model evaluation device may provide, via the application infrastructure, the modified data to a processing component of the application (e.g., a processing component executing via the application infrastructure). In some implementations, the model evaluation device may transmit, via an API call, the modified data to the processing component (e.g., based on, or in response to, replacing the first one or more outputs with the second one or more outputs in the application data). For example, the model evaluation device may be configured to automatically provide the modified application data to one or more processing components executing in the application infrastructure (e.g., after modifying the application data, as described above).

In some implementations, the model evaluation device may identify an address (e.g., an API endpoint) associated with a given processing component (e.g., from multiple processing components associated with the application). For example, the model evaluation device may determine the processing component based on the target variable(s) associated with the test model and/or based on the application data. For example, the application data may indicate a type or category of data. The model evaluation device may determine the processing component based on type or category of data. The model evaluation device may identify the address (e.g., the API endpoint) based on determining the processing component to which the modified application data is to be provided. The model evaluation device may transmit (e.g., via an API call) the modified application data to the identified address.

As shown by reference number 145, the application infrastructure may perform one or more operations using the modified application data. For example, one or more processing components may process, analyze, and/or compute information using the modified application data. In other words, one or more processing components may perform one or more processing operations using the modified application data.

In some implementations, the application infrastructure may generate evaluation information for the test model (e.g., based on the one or more processing operations performed using the modified application data). In some implementations, the evaluation information may include information or data that is calculated or otherwise generated using the modified application data (e.g., information calculated or otherwise generated via one or more processing components of the application infrastructure).

As shown by reference number 150, the application infrastructure may provide, and the model evaluation device may obtain the evaluation information for the test model. For example, the model evaluation device may obtain, based on providing the modified data, the evaluation information. The evaluation information may indicate a performance level of the test model. For example, the performance level may be based on the one or more processing operations performed via the processing component(s) (e.g., in the application infrastructure) using the modified data.

In some implementations, the evaluation information may indicate the performance level. In other implementations, the model evaluation device may determine the performance level using the evaluation information. For example, the performance level may be based on one or more performance metrics. The one or more performance metrics may include one or more classification metrics, one or more regression metrics, and/or one or more ranking metrics, among other examples. The one or more classification metrics may include an accuracy metric (e.g., a proportion of correctly classified samples to the total number of samples), a precision metric (e.g., a number of true positive samples divided by the sum of true positives and false positives), a recall metric (e.g., a number of true positive samples divided by the sum of true positives and false negatives, measuring the ability of the model to correctly identify positive samples), an F1 score metric, and/or an area under the receiver operating characteristic curve metric, among other examples. The one or more regression metrics may include a mean squared error metric, a mean absolute error metric, and/or an R-squared metric, among other examples. The one or more ranking metrics may include a mean average precision metric, and/or a normalized discounted cumulative gain metric, among other examples. The performance metric(s) used to evaluate the test model may be based on a problem and/or target variable(s) for which the test model is trained to address. In some implementations, the model evaluation device may perform one or more cross-validation and/or holdout tests using the evaluation information to determine the performance level of the test model.

The model evaluation device may use the evaluation information to determine the one or more performance metrics. The model evaluation device may determine the performance level of the test model based on the one or more performance metrics. For example, the performance level may indicate an overall performance of the test model (e.g., in association with the application infrastructure). In other words, the performance level may indicate the overall performance of the test model if the test model were to be deployed in the application infrastructure (e.g., without actually deploying the test model in the application infrastructure).

As shown in FIG. 1C, and by reference number 155, the model evaluation device may perform one or more actions based on the performance level. In some implementations, the one or more actions may include training (or re-training) the test model. For example, the model evaluation device may modify or tune one or more parameters (or hyperparameters) of the test model based on the performance level (e.g., to improve the performance level). In other words, the model evaluation device may use the performance level (e.g., evaluated based on the operation(s) performed via the application infrastructure, as described elsewhere herein) as part of a training operation of the test model.

In some implementations, the one or more actions may include causing the test model to be deployed via the application infrastructure. For example, if the performance level satisfies a performance threshold, then the model evaluation device may cause the test model to be deployed via the application infrastructure. If the performance level does not satisfy the performance threshold, then the model evaluation device may continue training the test model (e.g., as described above).

For example, as shown by reference number 160, the model evaluation device may cause, based on the performance level satisfying the performance threshold, the test model to be deployed via the application infrastructure. For example, the model evaluation device may transmit, to a component or device associated with the application infrastructure, an indication to deploy the test model via the application infrastructure. In some implementations, the model evaluation device may transmit, to a component or device associated with the application infrastructure, the test model to be deployed via the application infrastructure. As shown by reference number 165, a device and/or component of the application infrastructure may deploy the test model (e.g., based on, or in response to, receiving the indication from the model evaluation device). Deploying the test model may enable the test model to be accessed and/or used in connection with one or more application executing via the application infrastructure (e.g., based on the performance level indicating that the test model performs well in the application infrastructure).

In some implementations, as shown by reference number 170, the model evaluation device may provide, for display, an indication of the performance level. For example, the model evaluation device may cause an indication of the performance level to be displayed via the client device. For example, the client device may display (e.g., via a user interface) an indication of the performance level of the test model. This may enable a developer to quickly and easily view the performance level of the test model (e.g., without coordinating with other developers, teams, or devices).

As indicated above, FIGS. 1A-1C are provided as an example. Other examples may differ from what is described with regard to FIGS. 1A-1C.

FIG. 2 is a diagram of an example 200 associated with machine learning model evaluation. As shown in FIG. 2, example 200 depicts an example architecture associated with machine learning model evaluation. The example architecture includes a test model 205, a data pipeline 210, an application infrastructure 215 (e.g., including a data retrieval component 220, a data enrichment component 225, a data preprocessing component 230, one or more deployed models 235, and/or one or more processing components 240), and/or a storage component 245, among other examples.

The test model 205 may be similar to the test model described in connection with FIGS. 1A-1C. The data pipeline 210 may be, or may be included in, the model evaluation device described in connection with FIGS. 1A-1C (and elsewhere herein). The application infrastructure 215 may be configured to generate application data to be used for testing and/or evaluation of the test model 205. For example, the data retrieval component 220 may be configured to obtain and/or retrieve data (e.g., source data). The data enrichment component 225 may be configured to perform one or more data enrichment operations (to enhance the source data with additional information). The data preprocessing component 230 may be configured to perform one or more preprocessing operations using the enriched data to generate input data. The input data may be provided to the one or more deployed models 235. The one or more deployed models 235, based on obtaining the input data, may generate and/or output the application data. The application data may include one or more outputs generated by the one or more deployed models 235.

As shown by reference number 250, the one or more deployed models 235 and/or the application infrastructure 215 may be configured to store the application data in the storage component 245. As shown by reference number 255, the data pipeline 210 may obtain the application data via the storage component 245. The data pipeline 210 may obtain one or more outputs from the test model 205. For example, as shown by reference number 260, input data may be provided to the test model 205. The input data may be similar to, or the same as, the input data provided to the one or more deployed models 235. The test model 205 may generate one or more outputs based on obtaining the input data. As shown by reference number 265, the data pipeline 210 may obtain the one or more outputs associated with the test model 205.

As shown by reference number 270, the data pipeline 210 may modify the application data to replace output(s) of the one or more deployed models 235 with the output(s) of the test model 205. For example, the data pipeline 210 may modify the application data to indicate the one or more outputs associated with the test model 205, as described in more detail elsewhere herein. As shown by reference number 275, the data pipeline may provide, to the application infrastructure 215 and/or the one or more processing components 240, modified application data (e.g., indicating the output(s) of the test model 205).

The one or more processing components 240 may perform one or more operations using the modified application data. For example, as shown by reference number 280, the application infrastructure 215 and/or the one or more processing components 240 may output evaluation information (e.g., that is based on the modified application data). For example, the evaluation information may include information, communications, recommendations, calculations, and/or other data that is generated using the modified application data. As described in more detail elsewhere herein, the evaluation information may be used to determine a performance level of the test model 205.

As indicated above, FIG. 2 is provided as an example. Other examples may differ from what is described with regard to FIG. 2.

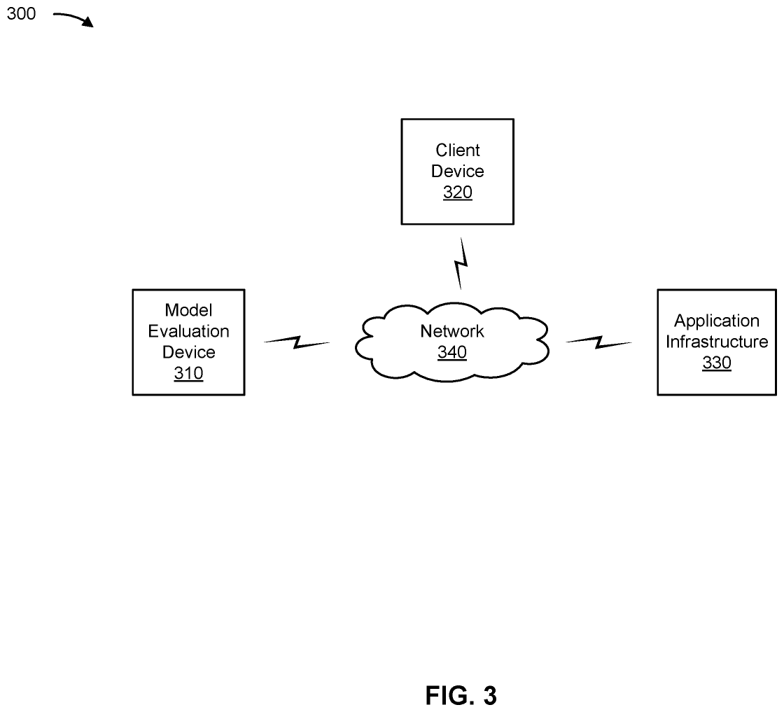

FIG. 3 is a diagram of an example environment 300 in which systems and/or methods described herein may be implemented. As shown in FIG. 3, environment 300 may include a model evaluation device 310, a client device 320, an application infrastructure 330, and a network 340. Devices of environment 300 may interconnect via wired connections, wireless connections, or a combination of wired and wireless connections.

The model evaluation device 310 may include one or more devices capable of receiving, generating, storing, processing, providing, and/or routing information associated with machine learning model evaluation, as described elsewhere herein. The model evaluation device 310 may include a communication device and/or a computing device. For example, the model evaluation device 310 may include a server, such as an application server, a client server, a web server, a database server, a host server, a proxy server, a virtual server (e.g., executing on computing hardware), or a server in a cloud computing system. In some implementations, the model evaluation device 310 may include computing hardware used in a cloud computing environment.

The client device 320 may include one or more devices capable of receiving, generating, storing, processing, and/or providing information associated with machine learning model evaluation, as described elsewhere herein. The client device 320 may include a communication device and/or a computing device. For example, the client device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The application infrastructure 330 may include one or more devices capable of receiving, generating, storing, processing, and/or providing information associated with machine learning model evaluation, as described elsewhere herein. The application infrastructure 330 may be similar to the application infrastructure 215. The application infrastructure 330 may be a computing environment in which one or more applications are executed. The application infrastructure 330 may include technologies, services, and/or computing resources that support the deployment and execution of one or more applications. For example, the application infrastructure 330 may include one or more hardware components (e.g., computing hardware, one or more server devices, one or more storage devices, one or more networking components, and/or one or more data centers), one or more operating systems (e.g., a host operating system), one or more resource management components (e.g., a virtualization application capable of virtualizing computing hardware), one or more virtual computing systems (e.g., a virtual environment that enables cloud-based execution of operations and/or processes described herein, such as a virtual machine, a container, or a hybrid environment that includes a virtual machine and a container), one or more web servers, one or more application servers, a database management system, network infrastructure (e.g., one or more routing devices (e.g., routers), one or more network switches, one or more load balancers, and/or one or more firewalls), one or more monitoring and/or logging components, one or more security components, one or more content delivery networks, one or more scaling or load balancing components, one or more integration services, and/or one or more application development components (e.g., one or more continuous integration/continuous deployment (CI/CD) tools), among other examples.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

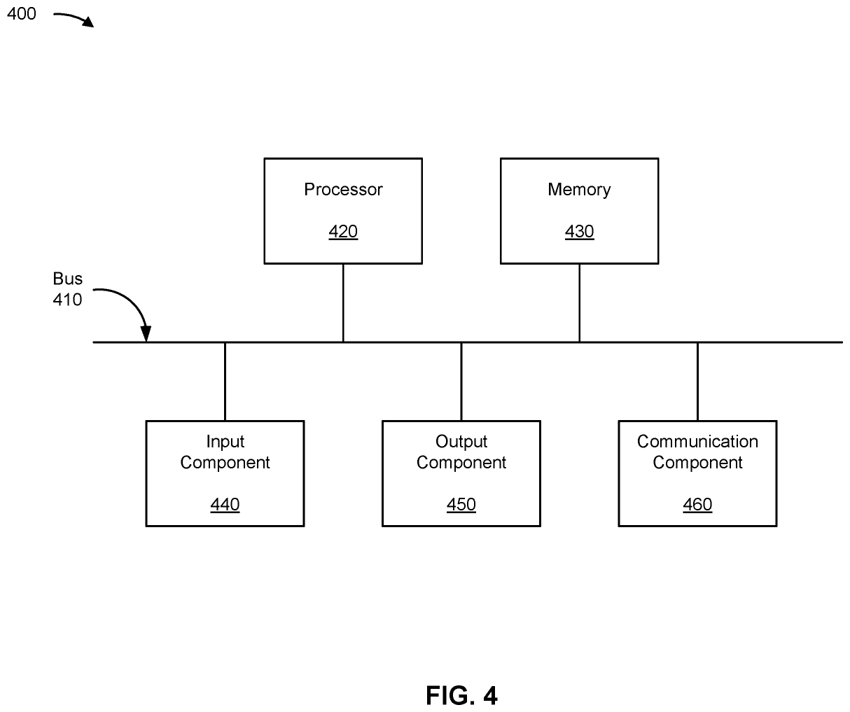

FIG. 4 is a diagram of example components of a device 400 associated with machine learning model evaluation. The device 400 may correspond to the model evaluation device 310, the client device 320, and/or the application infrastructure 330 (or one or more components of the application infrastructure 330). In some implementations, the model evaluation device 310, the client device 320, and/or the application infrastructure 330 (or one or more components of the application infrastructure 330) may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

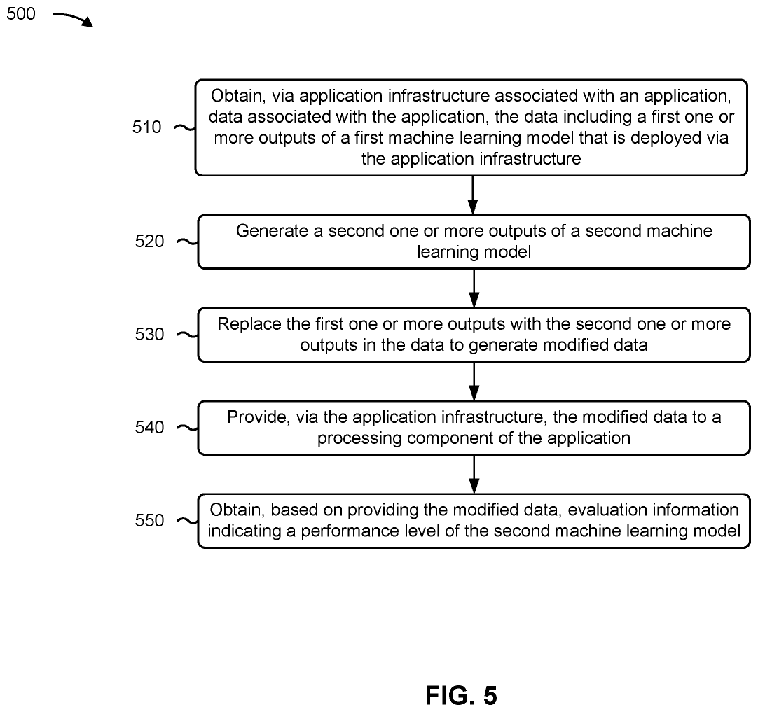

FIG. 5 is a flowchart of an example process 500 associated with machine learning model evaluation. In some implementations, one or more process blocks of FIG. 5 may be performed by the model evaluation device 310. In some implementations, one or more process blocks of FIG. 5 may be performed by another device or a group of devices separate from or including the model evaluation device 310, such as the client device 320 and/or the application infrastructure 330. Additionally, or alternatively, one or more process blocks of FIG. 5 may be performed by one or more components of the device 400, such as processor 420, memory 430, input component 440, output component 450, and/or communication component 460. Additionally, or alternatively, one or more process blocks of FIG. 5 may be performed by one or more components depicted in FIG. 2, such as the test model 205, the data pipeline 210, the application infrastructure 215, the data retrieval component 220, the data enrichment component 225, the data preprocessing component 230, the one or more deployed models 235, the one or more processing components 240, and/or the storage component 245.

As shown in FIG. 5, process 500 may include obtaining, via application infrastructure associated with an application, data associated with the application, the data including a first one or more outputs of a first machine learning model that is deployed via the application infrastructure (block 510). For example, the model evaluation device 310 (e.g., using processor 420 and/or memory 430) may obtain, via application infrastructure associated with an application, data associated with the application, the data including a first one or more outputs of a first machine learning model that is deployed via the application infrastructure, as described above in connection with reference number 125 of FIG. 1A. As an example, the model evaluation device 310 may obtain application data (e.g., generated via the application infrastructure using the first (one or more) machine learning model(s)) for a testing and/or evaluation of a test model (e.g., a second machine learning model).

As further shown in FIG. 5, process 500 may include generating a second one or more outputs of a second machine learning model (block 520). For example, the model evaluation device 310 (e.g., using processor 420 and/or memory 430) may generate a second one or more outputs of a second machine learning model, as described above in connection with reference number 130 of FIG. 1B. As an example, the model evaluation device may cause the second machine learning model (e.g., the test model) to output the second one or more outputs using input data that is the same, or similar, to input data used by the first machine learning model to generate the first one or more outputs.

As further shown in FIG. 5, process 500 may include replacing the first one or more outputs with the second one or more outputs in the data to generate modified data (block 530). For example, the model evaluation device 310 (e.g., using processor 420 and/or memory 430) may replace the first one or more outputs with the second one or more outputs in the data to generate modified data, as described above in connection with reference number 135 of FIG. 1B. As an example, the model evaluation device 310 may modify the data (e.g., generated via the application infrastructure) by replacing the first one or more outputs with the second one or more outputs.

As further shown in FIG. 5, process 500 may include providing, via the application infrastructure, the modified data to a processing component of the application (block 540). For example, the model evaluation device 310 (e.g., using processor 420 and/or memory 430) may provide, via the application infrastructure, the modified data to a processing component of the application, as described above in connection with reference number 140 of FIG. 1B. As an example, the model evaluation device may cause the modified data to be used or processed via one or more applications executing in the application infrastructure.

As further shown in FIG. 5, process 500 may include obtaining, based on providing the modified data, evaluation information indicating a performance level of the second machine learning model (block 550). For example, the model evaluation device 310 (e.g., using processor 420 and/or memory 430) may obtain, based on providing the modified data, evaluation information indicating a performance level of the second machine learning model, as described above in connection with reference number 150 of FIG. 1B. As an example, the evaluation information may include information that is calculated and/or generated using the modified data (e.g., the data that indicates the output(s) of the test model). The model evaluation device 310 may determine the performance level of the second machine learning model (e.g., the test model) using the evaluation information.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for machine learning model evaluation, the system comprising:
one or more memories; and
one or more processors, communicatively coupled to the one or more memories, configured to:
obtain, via application infrastructure associated with an application, data associated with the application, the data including a first one or more outputs of a deployed machine learning model associated with the application,
wherein the first one or more outputs are based on input data associated with the application;
generate, based on the input data, a second one or more outputs of a test machine learning model;
modify the data to obtain modified data associated with the application,
wherein the modified data includes the second one or more outputs in place of the first one or more outputs;
provide, via the application infrastructure, the modified data to a processing component of the application;
obtain, based on providing the modified data, evaluation information indicating a performance level of the test machine learning model; and
perform one or more actions based on the performance level.

2. The system of claim 1, wherein the application infrastructure include one or more modularized components,
wherein the one or more modularized components include the processing component and a scoring component, and
wherein the one or more processors, to obtain the data, are configured to:
obtain the data via the scoring component.

3. The system of claim 1, wherein the first one or more outputs are associated with a data format, and wherein the one or more processors, to generate the second one or more outputs, are configured to:
configure the second one or more outputs to have the data format.

4. The system of claim 1, wherein the first one or more outputs and the second one or more outputs are both associated with one or more target variables.

5. The system of claim 1, wherein the first one or more outputs are associated with a first one or more target variables and the second one or more outputs are associated with a second one or more target variables.

6. The system of claim 1, wherein the data includes one or more data fields indicating the first one or more outputs, wherein the one or more processors, to generate the second one or more outputs, are configured to:
configure the second one or more outputs to have a format of the one or more data fields, and
wherein the one or more processors, to modify the data, are configured to:
replace the one or more data fields with the second one or more outputs to obtain the modified data.

7. The system of claim 1, wherein the performance level satisfies a performance threshold, and wherein the one or more processors, to perform the one or more actions, are configured to:
cause, based on the performance level satisfying the performance threshold, the test machine learning model to be deployed via the application infrastructure.

8. A method for machine learning model evaluation, comprising:
obtaining, by a device and via application infrastructure associated with an application, data associated with the application, the data including a first one or more outputs of a first machine learning model that is deployed via the application infrastructure;
generating, by the device, a second one or more outputs of a second machine learning model;
replacing, by the device, the first one or more outputs with the second one or more outputs in the data to generate modified data;
providing, by the device and via the application infrastructure, the modified data to a processing component of the application; and
obtaining, by the device and based on providing the modified data, evaluation information indicating a performance level of the second machine learning model.

9. The method of claim 8, wherein the performance level is based on one or more processing operations performed via the processing component using the modified data.

10. The method of claim 8, further comprising:
receiving a request to evaluate the second machine learning model; and
obtaining, in response to the request, the second machine learning model,
wherein generating the data associated with the application is in response to the request.

11. The method of claim 8, wherein providing the modified data comprises:
transmitting, via an application programming interface (API) call, the modified data to the processing component based on replacing the first one or more outputs with the second one or more outputs in the data.

12. The method of claim 8, wherein generating the data associated with the application comprises:
preprocessing, via the application infrastructure, input data to obtain preprocessed data; and
providing, via the application infrastructure, the preprocessed data to the first machine learning model to obtain the first one or more outputs, and
wherein generating the second one or more outputs comprises:
providing, to the second machine learning model, the preprocessed data; and
obtaining, based on providing the preprocessed data, the second one or more outputs.

13. The method of claim 8, further comprising:
performing one or more actions based on the performance level.

14. The method of claim 8, wherein the application infrastructure include one or more modularized components, wherein the one or more modularized components include the processing component and a scoring component configured to execute the first machine learning model.

15. The method of claim 8, wherein the first one or more outputs are associated with a data format, and wherein generating the second one or more outputs comprises:
configuring the second one or more outputs to have the data format.

16. A non-transitory computer-readable medium storing a set of instructions, the set of instructions comprising:
one or more instructions that, when executed by one or more processors of a device, cause the device to:
generate, via application infrastructure associated with an application, data associated with the application, the data including a first one or more outputs of a deployed machine learning model associated with the application;
obtain a second one or more outputs of a test machine learning model;
modify the data to obtain modified data associated with the application,
wherein the modified data includes the second one or more outputs in place of the first one or more outputs;
provide, via the application infrastructure, the modified data to a processing component of the application; and
obtain, based on providing the modified data and via the application infrastructure, evaluation information indicating a performance level of the test machine learning model.

17. The non-transitory computer-readable medium of claim 16, wherein the one or more instructions, when executed by the one or more processors, further cause the device to:
provide, for display, an indication of the performance level.

18. The non-transitory computer-readable medium of claim 16, wherein the application infrastructure include one or more modularized components including the processing component and a scoring component.

19. The non-transitory computer-readable medium of claim 16, wherein the first one or more outputs and the second one or more outputs are both associated with one or more target variables.

20. The non-transitory computer-readable medium of claim 16, wherein the data includes one or more data fields indicating the first one or more outputs, wherein the one or more processors, to obtain the second one or more outputs, are configured to:
configure the second one or more outputs to have a format of the one or more data fields, and
wherein the one or more instructions, that cause the device to modify the data, cause the device to:
replace the one or more data fields with the second one or more outputs to obtain the modified data.
